(19) United States
(12) Patent Application Publication
(10) Pub. No.: US 2008/0078715 A1
(43) Pub. Date: Apr. 3, 2008

(54) Ion Exchange and Particulate Filter Assembly

(76) Inventor: Jason W. Reid, Gastonia, NC (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/626,021

(22) Filed: Jan. 23, 2007

Related U.S. Application Data
(60) Provisional application No. 60/827,970, filed on Oct. 3, 2006.

(51) Int. Cl. B01D 27/02

(52) U.S. Cl. 210/266; 210/282

(57) ABSTRACT

A fluid filter comprising a housing having walls defining a cavity, a particulate filter medium contained in a first portion of the cavity, an ion exchange member contained in a second portion of the cavity, wherein the particulate filter medium and the ion exchange member at least partially define a parallel fluid pathway for fluid entering the housing cavity, wherein a first portion of the fluid pathway by-passes the particulate filter medium and passes through the ion exchange member without passing through any particulate filter medium in the housing, and wherein a second portion of the fluid pathway passes through the particulate filter medium.

### RELATED APPLICATIONS

This application claims the benefit of earlier filed U.S. Provisional Application Ser. No. 60/827,970, filed Oct. 3, 2006, which is incorporated herein by reference in its entirety.

### TECHNICAL FIELD

This invention relates to ion exchange members, to particulate filter members and to ion exchange members and particulate filter members arranged within a common housing.

### BACKGROUND OF THE INVENTION

Ion exchange assemblies and particulate filter assemblies are known. Such known ion exchange assemblies and particulate filter assemblies are provided as separate assemblies and are fluidly connected to one another by a separate piece, such as a flow regulator or a flow separator disposed between the ion exchange assembly and the particulate filter assembly. For example, U.S. Pat. No. 6,350,379, assigned to Wix Filtration Corp., describes one type of a flow separator which can be used between a conventional filter assembly and a particulate filter assembly.

### SUMMARY

A fluid filter comprising a housing having walls defining a cavity, a particulate filter medium contained in a first portion of the cavity, an ion exchange member contained in a second portion of the cavity, wherein the particulate filter medium and the ion exchange member at least partially define a parallel fluid pathway for fluid entering the housing cavity, wherein a first portion of the fluid pathway by-passes the particulate filter medium and passes through the ion exchange member without passing through any particulate filter medium in the housing, and wherein a second portion of the fluid pathway passes through the particulate filter medium.

### BRIEF DESCRIPTION OF THE DRAWINGS

FIG. 1 is an exploded view of a combination ion exchange and particulate filter in accordance with an embodiment of the invention;

FIG. 2 is a front perspective view of an ion exchange member in accordance with an embodiment of the invention;

FIG. 3 is a rear perspective view of the ion exchange member of FIG. 2;

FIG. 4 is a cross-sectional of a combination ion exchange and particulate filter assembly in accordance with an embodiment of the invention; and

FIG. 5 is a cross-sectional view of a combination ion exchange particulate filter assembly in accordance with an embodiment of the invention.

### DETAILED DESCRIPTION

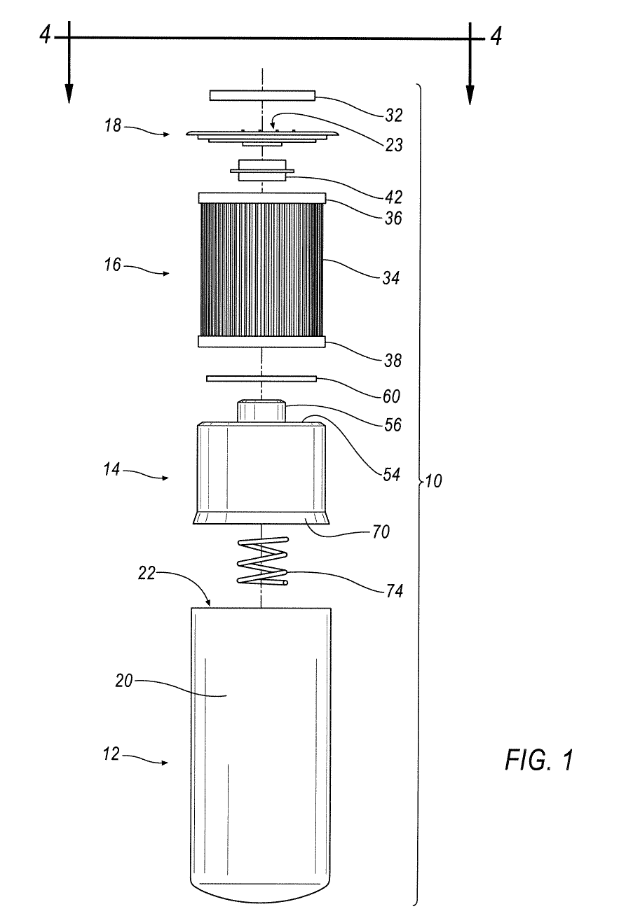

Referring now to the Figures, a combination ion exchange and particulate filter assembly 10 (“filter assembly”) is shown in accordance embodiments of the invention. With reference to the embodiment depicted in FIG. 1, filter assembly 10 generally includes a housing 12, an ion exchange member 14, a particulate filter member 16 (“filter member”) and a cover plate 18.

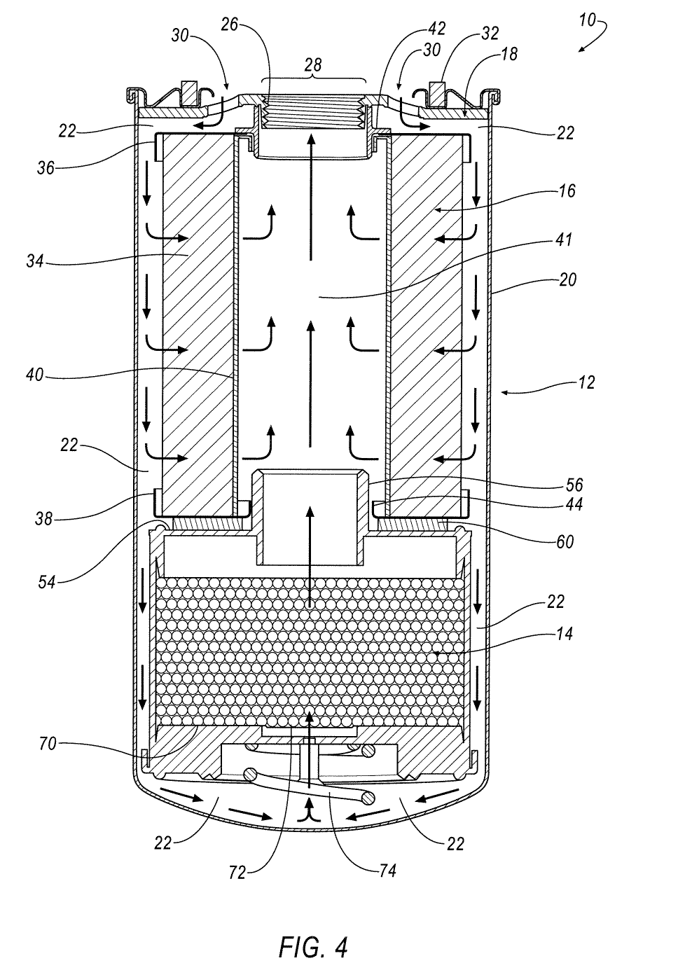

In an embodiment, housing 12 includes a sidewall 20 that defines a cavity 22 (see FIG. 4) within housing 12. In an embodiment, cavity 22 houses ion exchange member 14 and filter member 16 therewithin. Cover plate 18 is attached to an end of housing 12 to retain ion exchange member 14 and filter member 16 within housing 12 as will be described hereinafter.

Referring to FIG. 4, in an embodiment, cover plate 18 includes a circumferential sidewall 26 that extends axially inward, toward filter member 16 and defines an opening 28. In an embodiment, opening 28 is a fluid port for filtered fluid (fluid filtered from at least one of filter member 16 and/or ion exchange member 14) to egress from housing 14, filter member 16 and/or ion exchange member 14. Radially exterior to sidewall 26, cover plate 18 further defines one or more apertures 30 that extend through cover plate 18. In an embodiment, aperture(s) 30 defines a fluid port for unfiltered fluid to enter into housing 12 and potentially become filtered by at least one of filter member 16 and ion exchange member 14 and subsequently pass through opening 28. While apertures 30 defined by cover plate 18 have been described to allow fluid to enter housing 12, various configurations for such fluid entrance will become obvious to one of ordinary skill in the art after consulting this disclosure and the invention should not be limited to the particular configuration disclosed herein. Also, the function of apertures 30 and opening 28 can be reversed so that incoming fluid can enter through opening 28, and apertures 30 function as exit portals.

In an embodiment and as illustrated in FIG. 1 and FIG. 4, cover plate 18 includes a gasket 32 affixed to an exterior side thereof. In an embodiment a radially interior surface of sidewall 26 can include threads such that filter assembly 10 can threadably engage a corresponding threaded element (not shown). It will become appreciated that in such an embodiment, filter assembly 10 can be spun onto the threaded element (not shown) for convenient attachment thereto. It will also be appreciated that the foregoing embodiment is exemplary and the invention should not be limited to the foregoing connective system.

With continued reference to FIG. 4, filter member 16 comprises a filter media 34 and first and second end caps 36, 38 provided on axial ends of filter media 34. Filter media 34 defines an interior portion 41 between end caps 36, 38. In an embodiment, filter media 34 is formatted to filter unwanted particulates or the like present within the fluid passing therethrough. In an embodiment, a support 40 (such as a tube or the like) is provided radially interior to the filter media that generally extends between first and second end caps 36, 38. While a support 40 separate from first end cap 36 and second end cap 38 is shown and described based on this disclosure, it is to become appreciated that either one of said caps may define support 40 and the invention should not be limited to the exemplary embodiment. Moreover, it will be recognized that support 40 may be wholly omitted and the invention may be practiced without support 40.

In an embodiment, support 40 is a tube and can include radial apertures (not shown) for permitting filtered fluid to enter interior portion 41 after passing through the filter media 34. Thereafter, fluid residing in interior portion 41 can exit through first end cap 36 and opening 28. Thus, as the fluid stream enters housing 12 via apertures 30 resident on cover plate 18, fluid can pass through filter media 16 and egress from housing 12 through support 40 and first end cap 36. In an embodiment, the fluid that passes through filter media 16 does not correspondingly pass through ion exchange member 14 and vice versa such that the flow of entering fluid is split in a parallel flow path.

In an embodiment, first end cap 36 is formatted to sealingly engage cover plate 18. Referring to FIG. 1 and FIG. 4, a support element 42 may be provided between cover plate 18 to facilitate such engagement and remove stress exerted upon first end cap 36. In an embodiment, second end cap 38 is, likewise, formatted to sealingly engage ion exchange member 14. In an embodiment, second end cap 38, defines a recessed portion 44 (see FIG. 4) for facilitating fluid acceptance from ion exchange assembly into flow conduit 40 as will be discussed hereinafter.

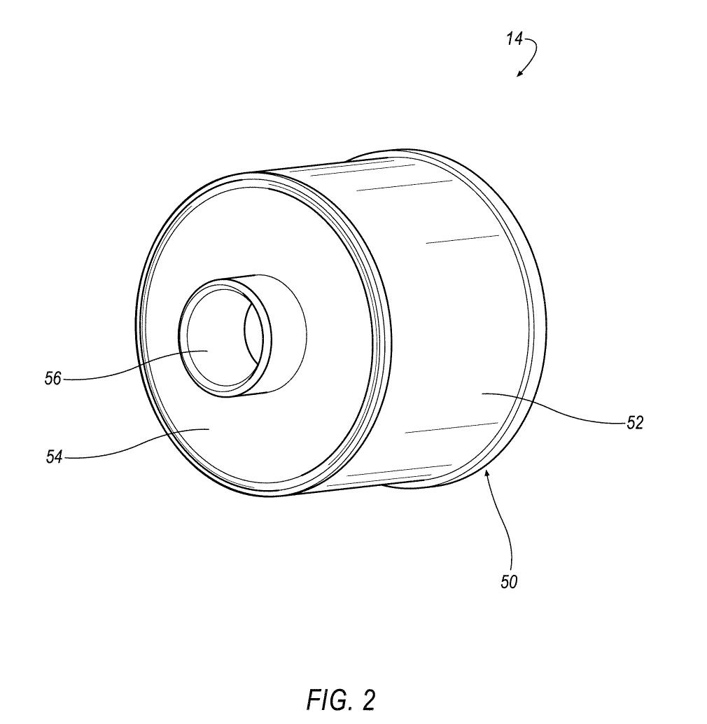

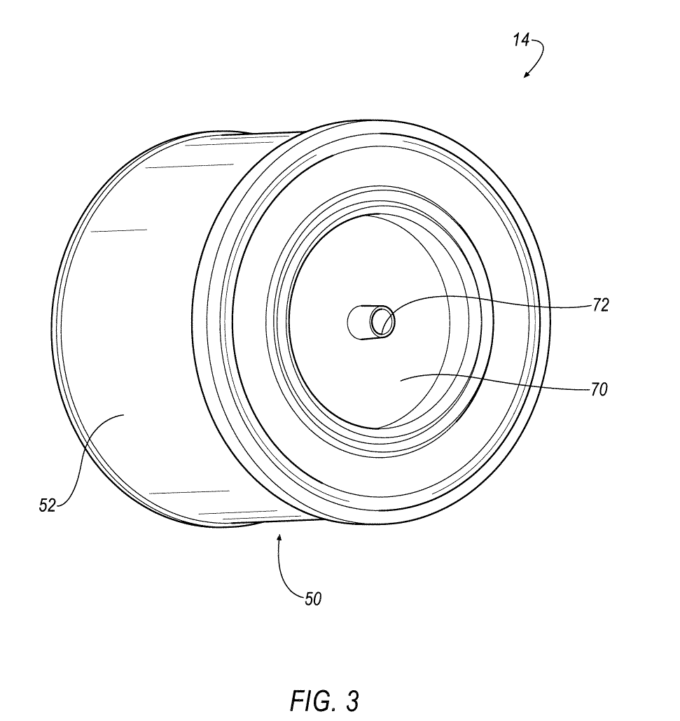

Referring now to FIG. 2 and FIG. 3, ion exchange member 14 comprises a canister 50 having sidewalls 52 extending between a first end 54 and a second end 70. Referring to FIG. 2, in an embodiment, first end 54 of ion exchange member 14 includes a projection 46 formatted to correspond with recessed portion 44 of second end cap 38 and flow conduit 40. In an embodiment, projection 46 defines an outlet fluid port adapted for fluid communication between flow conduit 40 and ion exchange member 14 such that fluid can egress from ion exchange member 14 and enter into an interior portion of filter element 10. In an embodiment, this entrance of fluid into the interior portion 41 of filter element 10 allows such fluid to bypass the filter media 34. It is to be understood that while projection 56 can be omitted and the invention practiced there without, such a projection 56 facilitates improved connection between ion exchange member 14 and the interior portion 41 of filter member 16. Referring now to FIG. 4, in an embodiment a washer 60 can be provided between surfaces of filter member 16 and ion exchange member 14. In an embodiment, washer 60 is made of a cork material, however, other types of materials can be used for such washers 60 can be substituted therefor and the invention should not be so limited thereby.

With reference now to FIG. 3, in an embodiment, second end 70 of ion exchange member 14 defines an inlet fluid port for 72 for allowing fluid to enter ion exchange member 14. In an embodiment, a biasing element 74 can be provided between second end 70 of ion exchange member 14 and housing 12. In an embodiment and as shown by the drawings, the biasing means can be a coil spring, however, other types of biasing means 74 may be substituted therefor. It is appreciated that the biasing means restricts unwanted displacement between ion exchange member 14 and filter member 16. It is appreciated that other restriction means may be substituted therefor and the foregoing restriction means should not be used to limit the inventive scope of the following claims.

In an embodiment, canister 52 contains ion exchange material, for example, ion exchange resin. In an embodiment, the ion exchange resin may be provided in a bead format. In an embodiment, such resin beads are provided to absorb acid present in the fluid passing therethrough. In an embodiment, such acid removal facilitates increased life of the fluid.

As will be understood by the foregoing structure and as described hereinabove, in an embodiment, the fluid flow through the filter member 16 is parallel with the fluid flow through the ion exchange member 14. It is appreciated that, among other factors, the density of the filter element media 34 and the size of fluid inlet port 72 of ion exchange member 14 can be modified to accommodate a desired volumetric fluid flow ratio between the fluid passing through the filter member 16 and the fluid passing through the ion exchange member 14. It is to be understood that the modification thereof is, generally, application specific. In an embodiment, the filter assembly 10 is arranged such that about ninety percent (90%) by volume of the fluid entering housing will pass through the filter media 34 and about ten percent (10%) by volume will pass through the ion exchange member 14.

An exemplary method for assembling filter assembly 10 will now be described. For brevity, a single method for assembly is described, but it will be appreciated that upon considering the principles outlined herein, and the familiarizations gleaned thereby, one of ordinary skill in the art will recognize that various modifications can be made to this exemplary method for assembly such that the invention should not be limited to the exemplary embodiment and is entitled to the full scope and breadth contemplated hereby and according to the scope of the claims that follow.

In an embodiment, the method is as follows: (1) cover plate 18 (with or without gasket) is placed on a surface; (2) support element 42 is placed on top of cover plate 18; (3) filter member 16 is placed on top of support element 42; (4) washer 60 is placed on top of filter member 16 to create a seal between the filter member 16 and ion exchange member 14; (5) ion exchange member 14 is placed on top of the washer 60; biasing element 74 is placed on top of the ion exchange member 14; (6) housing 12 is placed over the entire assembly and seamed to cover plate 18. In an embodiment, the seam between housing 12 and cover plate 18 is a double seam.

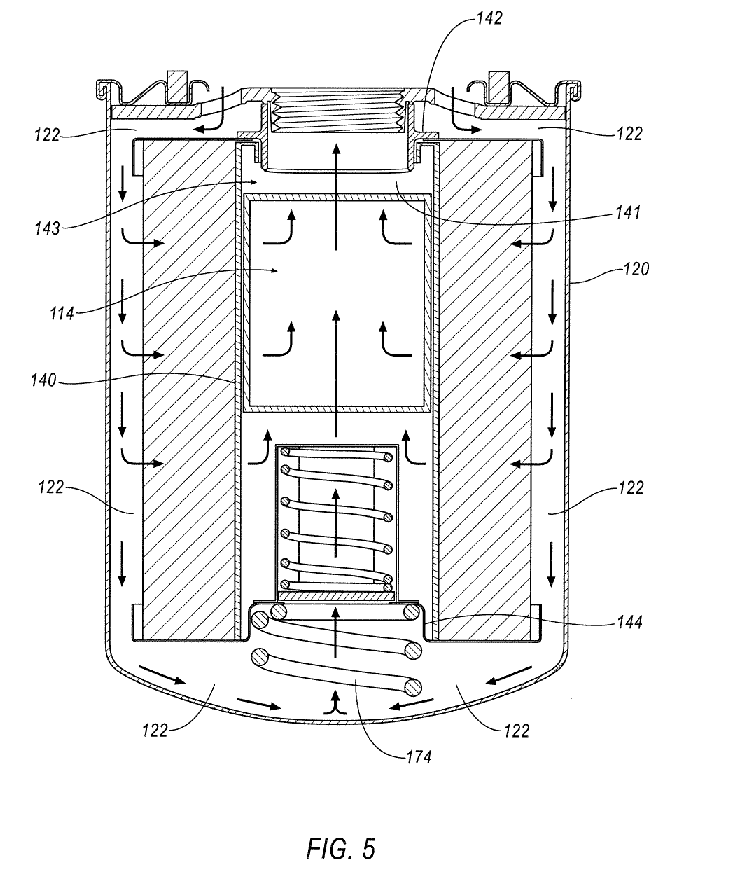

Referring now to FIG. 5, another combination ion exchange and particulate filter assembly 100 (“filter assembly”) is shown in accordance with another exemplary embodiment of the invention. With reference to the embodiment depicted in FIG. 5, filter assembly 100 includes a housing 112, an ion exchange member 114, a particulate filter member 116 (“filter member”) and a cover plate 118.

In an embodiment housing 112 includes a sidewall 120 that defines a cavity 122 within housing 112. In an embodiment, cavity 122 houses ion exchange member 114 and filter member 116 therewithin. Cover plate 118 is attached to an end of housing 112 to retain ion exchange member 114 and filter member 116 within housing 112.

In an embodiment, cover plate 118 includes a circumferential sidewall 126 that extends axially inward, toward filter member 116 and defines an opening 128. In an embodiment, opening 128 is a fluid port for filtered fluid (fluid filtered from at least one of filter member 116 and/or ion exchange member 114) to egress from housing 114, filter member 116 and/or ion exchange member 114. Radially exterior to sidewall 126, cover plate 118 defines one or more apertures 130 that extend through cover plate 118. In an embodiment, the one or more apertures 130 define a fluid port for unfiltered fluid to enter into housing 112 and potentially become filtered by at least one of filter member 116 and ion exchange member 114 and subsequently egress from housing 114 via opening 128. While apertures 130 defined by a cover plate 118 have been described to allow fluid to enter housing 112, various configurations for such fluid entrance will become obvious to one of ordinary skill in the art after consulting this disclosure and the invention should not be limited to the particular configuration disclosed herein. It should also be recognized based on this disclosure, that the function of one or more apertures 130 and opening 128 can be reversed so that incoming fluid can enter through opening 128 such that apertures 130 thereafter function as exit portals for this fluid.

In an embodiment and as described hereinbefore, cover plate 118 may include a gasket 132 affixed to an exterior side thereof. In an embodiment, a radially interior surface of sidewall 126 can include threads such that filter assembly 110 can threadably engage a corresponding threaded element (not shown). It will become appreciated in that such an embodiment filter assembly 110 can be spun onto the threaded element (not shown) for convenient attachment thereto. It will also be appreciated that the foregoing embodiment is exemplary and the invention should not be limited to the foregoing connective system.

With continued reference to FIG. 5, filter member 116 comprises a filter media 134 and first and second end caps 136, 138 provided on axial ends of filter media 134. In an embodiment, filter media 134 is formatted to filter unwanted particulates or the like present within the fluid passing therethrough. Without limiting the breadth of the foregoing, in an embodiment, a support 140 (such as a tube or the like) is provided radially interior to the filter media and generally extends between first and second end caps 136, 138. In an embodiment, first end cap 36 defines an opening at a central portion that sealingly corresponds with opening 128 defined by cover plate 118. The other end cap 138, sealingly and selectively closes off filter media 34. In an embodiment, second end cap 138 defines an imperforate reception well 139, which will be discussed hereinafter. In an alternative embodiment, and as illustrated in FIG. 5, a bypass valve may be used in conjunction with the end cap 138. In an embodiment, bypass valve allows fluid to pass through second end cap 138 when the pressure within housing reaches a pre-determined limit.

It is seen from the drawings, that the first end cap 136 and the second end cap 138 define a core 141 or interior area. It will become appreciated, that for fluid to enter into interior area 141, it must first pass through filter media 134, or through the bypass valve.

In an embodiment, ion exchange member 114 is disposed within interior area 141. In accordance with this configuration, fluid first passes through filter media 134 before entering ion exchange member 114.

In an embodiment, ion exchange member 114 is arranged within interior area 141 proximate to an end 143 of interior area 141 closer to opening 128. In an embodiment, ion exchange member 114 defines an outer diameter that correspondingly engages with an inner diameter of flow conduit 140. Based on this disclosure, various alternative configurations and positions for the ion exchange filter 114 will become readily recognizable and the invention should be entitled to the full breadth encaptured thereby.

For example and among others, ion exchange member 114 may be disposed anywhere within interior cavity 141. It is to be appreciated that ion exchange member 114 may be disposed within cavity to selectively control a ratio of fluid passing through ion exchange member 114. It will become understood, that this ratio and the position of ion exchange member 114 is application specific and the invention should not be so limited thereby.

In an embodiment, ion exchange member 114 may be a bay of ion exchange resin. Ion exchange member 14 may be a canister as shown in FIG. 2 and FIG. 3. These and other ion exchange member 114 variations should become readily apparent upon considering this disclosure.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

1. A fluid filter, comprising:
a housing having walls defining a cavity;
a particulate filter medium contained in a first portion of the cavity; and
an ion exchange member contained in a second portion of the cavity,
wherein the particulate filter medium and the ion exchange member at least partially define a parallel fluid pathway for fluid entering the housing cavity, wherein a first portion of the fluid pathway by-passes the particulate filter medium and passes through the ion exchange member without passing through any particulate filter medium in the housing, and wherein a second portion of the fluid pathway passes through the particulate filter medium.

2. The filter according to claim 1, wherein said particulate filter medium is ring-shaped having first and second axial ends and defines a core therewithin, and wherein the core forms a part of the second portion of the fluid pathway.

3. The filter according to claim 2, wherein the core forms a part of the first portion of the fluid pathway.

4. The filter according to claim 2, further comprising a flow conduit disposed in the core of the particulate filter medium, wherein the flow conduit partially defines the first portion of the fluid pathway.

5. The filter according to claim 4, wherein the flow conduit defines one or more radial apertures to partially define the second portion of the fluid pathway.

6. The filter according to claim 2, further comprising a first end cap at the first end of the particulate filter medium and a second end cap at the second end of the filter medium, wherein the flow conduit extends from one or both of the first end cap and the second end cap toward the other end cap.

7. The filter according to claim 1, wherein the housing includes a closed end and an open end, and wherein the ion exchange member is arranged proximate to the closed end of the housing and an outlet port of the ion exchange member extends toward the open end of said housing and into the core of the filter medium.

8. The filter according to claim 7, further comprising:
a bias member disposed between the closed end of the housing and the ion exchange member to urge the ion exchange member toward the open end of the housing.

9. The filter according to claim 1, wherein the first portion of the fluid pathway at least partially directs a first fluid volume through the ion exchange member and the second portion of the fluid pathway at least partially directs a second fluid volume through the particulate medium, and wherein the first fluid volume is less than the second fluid volume.

10. The filter according to claim 4, wherein a ratio between the first fluid volume and the second fluid volume is between 1:3 and 1:20.

11. The filter according to claim 5, wherein the ratio between said first fluid volume and the second fluid volume is at or around 1:9.

12. The filter according to claim 1, further comprising:
a housing cap having sidewalls that axially extend into the cavity and define an opening, the opening partially defining both the first portion of the pathway and the second portion of the pathway.

13. The filter according to claim 12, wherein the housing cap is integral with said housing.

14. A filter system for filtering fluid, said filter system comprising:
a housing having a fluid inlet and a fluid outlet;
a particulate filter element arranged within the housing, said particulate filter element having a particulate filter medium that defines an interior portion and an exterior portion;
an ion exchange assembly arranged within the housing, said ion exchange assembly having a fluid inlet and a fluid outlet;
a first fluid flow path that directs a first fluid amount through said particulate filter medium of said particulate filter element and into the interior portion of the particulate filter element; and
a second fluid flow path that directs a second fluid amount through the ion exchange assembly via the fluid inlet and the fluid outlet and into the interior portion of the particulate filter element,
wherein the fluid directed through said second fluid flow path does not pass through any particulate filter medium in said housing, including said particulate filter medium of said particulate filter element.

15. The filter system according to claim 14, further comprising a flow conduit disposed in said interior portion of said particulate filter element, wherein said flow conduit is provided in fluid communication with said fluid outlet of said ion exchange assembly.

16. The filter according to claim 15, wherein said flow conduit defines one or more radial apertures such that fluid passing through said ring of particulate filter medium can enter said flow element.

17. The filter according to claim 14, wherein said particulate filter medium includes first and second axial ends, and wherein said filter element includes a first end cap at said first axial end of said ring of particulate filter medium and a second end cap at said second axial end of said ring of particulate filter medium, and further wherein said flow element extends from one or both of said first end cap and said second end cap toward said other end cap.

18. The filter according to claim 14, wherein said housing includes a closed end and an open end, and wherein said inlet port of said ion exchange assembly is arranged proximate to said closed end of said housing and said outlet port of said ion exchange assembly extends toward said open end of said housing and into said interior portion of said filter element.

19. The filter according to claim 18, further comprising:
a bias member disposed between said closed end of said housing and said inlet port of said ion exchange assembly, said bias member generally urging said ion exchange assembly toward said open end of said housing.

20. The filter according to claim 14, further comprising:
a housing cap having sidewalls that axially extend into said cavity and define an opening that defines said fluid outlet of said housing, said opening in direct fluid communication with said interior portion of said filter element such that fluid resident therewith can exit the filter.

21. The filter element comprising:
a pleated filter media,
first and second end caps sealingly engaged to the pleated filter media at axial ends defining an interior area; and
an ion exchange member disposed within said interior area.
